(19) United States
(12) Patent Application Publication
(10) Pub. No.: US 2017/0299436 A1
(43) Pub. Date: Oct. 19, 2017

(54) SPECTRAL-IMAGE ACQUISITION DEVICE

(71) Applicant: OLYMPUS CORPORATION, Tokyo (JP)

(72) Inventor: Gen HORIE, Tokyo (JP)

(73) Assignee: OLYMPUS CORPORATION, Tokyo (JP)

(21) Appl. No.: 15/642,262

(22) Filed: Jul. 5, 2017

Related U.S. Application Data
(63) Continuation of application No. PCT/JP2015/050242, filed on Jan. 7, 2015.

(51) Int. Cl. G01J 3/28; G06T 7/70; G01J 3/02; G01J 3/30

(52) U.S. Cl. CPC G01J 3/2823; G01J 3/30; G06T 7/70; G01J 3/0232

(57) ABSTRACT

This spectral-image-obtaining device includes: a line-spectral-image acquiring unit that acquires a plurality of line spectral images; a frame-image acquiring unit that has an image-capturing range that encompasses that over which image capturing is performed by the line-spectral-image acquiring unit and that acquires a two-dimensional frame image that contains fewer color signals than the line spectral images; a comparison-image estimating unit that estimates comparison images for all lines based on the line spectral images acquired by the line-spectral-image acquiring unit and a wavelength characteristic of the frame-image acquiring unit; a line-spectral-image positional-deviation detecting unit that detects amounts of positional deviation between the comparison images estimated by the comparison-image estimating unit and corresponding positions within the frame image; and a positional-deviation correcting unit that fits the line spectral images to corresponding positions within the frame image based on the amounts of positional deviation detected by the line-spectral-image positional-deviation detecting unit.

### CROSS-REFERENCE TO RELATED APPLICATIONS

This is a continuation of International Application PCT/JP2015/050242, with an international filing date of Jan. 7, 2015, which is hereby incorporated by reference herein in its entirety.

### TECHNICAL FIELD

The present invention relates to a spectral-image acquisition device.

### BACKGROUND ART

There is a known image-processing device for a scanner that includes R, G, and B line sensors and a white/black line sensor that are arrayed in a sub-scanning direction. The image-processing device generates luminance signals by selecting signals that are read out from the sensors at different timings while feeding an original in the sub-scanning direction. As signals that have been corrected for positional deviation, the image-processing device outputs R, G, and B signals, which are the basis of luminance signals having, among generated luminance signals, the highest correlation with a white/black line sensor signal (for example, refer to PTL 1).

### CITATION LIST

### Patent Literature

### {PTL 1} Publication of Japanese Patent No. 5393445

### SUMMARY OF INVENTION

An aspect of the present invention provides a spectral-image acquisition device that includes: a line-spectral-image acquiring unit that acquires a plurality of line spectral images by deflecting a scanned line-shaped light beam across all wavelengths at each position in a length direction thereof; a frame-image acquiring unit that has an image-capturing range that encompasses that over which image capturing is performed by the line-spectral-image acquiring unit, and that acquires a two-dimensional frame image that contains fewer color signals than the line spectral images; a comparison-image estimating unit that estimates comparison images for all lines on the basis of the line spectral images acquired by the line-spectral-image acquiring unit and a wavelength characteristic of the frame-image acquiring unit; a line-spectral-image positional-deviation detecting unit that detects amounts of positional deviation between the comparison images estimated by the comparison-image estimating unit and corresponding positions within the frame image; and a positional-deviation correcting unit that fits the line spectral images, which were used to estimate the comparison images, to the corresponding positions within the frame image on the basis of the amounts of positional deviation detected by the line-spectral-image positional-deviation detecting unit.

### BRIEF DESCRIPTION OF DRAWINGS

FIG. 1 is an overall configuration diagram illustrating a spectral-image acquisition device according to a first embodiment of the present invention.

FIG. 2 is an enlarged view illustrating a line-spectral-image acquiring unit that is provided in an image-acquiring unit of the spectral-image acquisition device in FIG. 1.

FIG. 3 is a diagram for describing a line spectral image acquired by the line-spectral-image acquiring unit in FIG. 2.

FIG. 4 is a block diagram illustrating an image-processing unit that is provided in the spectral-image acquisition device in FIG. 1.

FIG. 5 is a diagram for describing the operation of an estimated-value calculating unit that is provided in the image-processing unit in FIG. 4.

FIG. 6 is a block diagram illustrating a positional-deviation correcting unit that is provided in the image-processing unit in FIG. 4.

FIG. 7 illustrates a case in which reference images and line spectral images are simultaneously acquired in a spectral-image acquisition device according to a second embodiment of the present invention.

FIG. 8 is a block diagram illustrating an image-processing device of the spectral-image acquisition device in FIG. 7.

FIG. 9 is a diagram for describing another modification of the spectral-image acquisition device in FIG. 1.

FIG. 10 is a diagram for describing another modification of the spectral-image acquisition device in FIG. 1.

FIG. 11 is a diagram for describing another modification of the spectral-image acquisition device in FIG. 1.

FIG. 12 is a block diagram illustrating an image-processing device of the spectral-image acquisition device in FIG. 11.

FIG. 13 is a block diagram illustrating an inter-reference-image positional-deviation detecting unit of the spectral-image acquisition device in FIG. 11.

FIG. 14 is a block diagram illustrating another modification of the inter-reference-image positional-deviation detecting unit in FIG. 13.

FIG. 15 is a diagram for describing another modification of the spectral-image acquisition device in FIG. 1.

### DESCRIPTION OF EMBODIMENTS

Hereafter, a spectral-image acquisition device 1 according to a first embodiment of the present invention will be described while referring to the drawings.

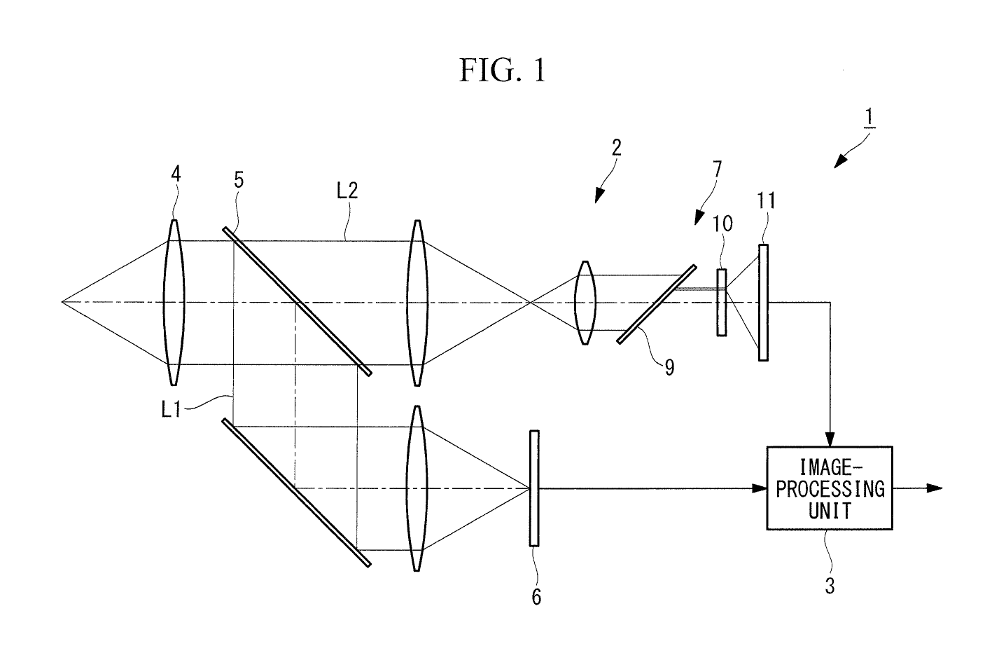

As illustrated in FIG. 1, the spectral-image acquisition device 1 according to this embodiment includes an image-acquiring unit 2 and an image-processing unit 3.

The image-acquiring unit 2 includes an image-capturing lens 4 that collects light from a subject, a splitting unit 5 that branches the light from the subject collected by the image-capturing lens 4 into two optical paths L1 and L2, a reference-image acquiring unit (frame-image acquiring unit) 6 that is arranged along one optical path L1 branched by the splitting unit 5 and that acquires a reference image (frame image) by capturing a two-dimensional image of the subject, and a line-spectral-image acquiring unit 7 that is arranged along the other optical path L2 and acquires line spectral images of the subject.

The splitting unit 5 is a half mirror, example.

The reference-image acquiring unit 6 includes a monochrome area sensor such as a CCD or CMOS image sensor.

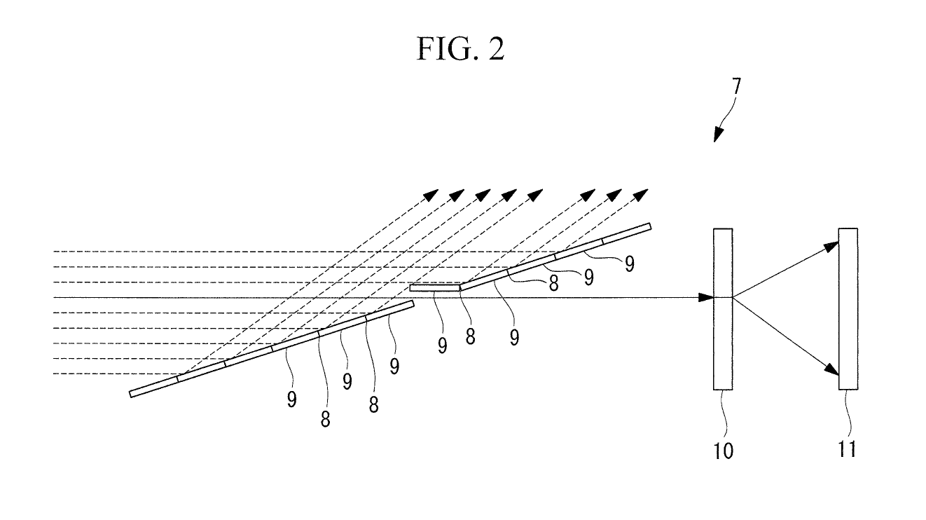

As illustrated in FIG. 2, the line-spectral-image acquiring unit 7 includes: silts 8 that are arranged along the other optical path L2 in a plurality of rows; a plurality of shutters 9 that are provided so as to be capable of opening and closing the slits 8 in the corresponding rows, that allow light from the subject to pass therethrough when open, and that block light from the subject when closed; a diffraction grating 10 that is disposed on the opposite side from the subject with the shutters 9 interposed therebetween, and that emits light incident thereon in different diffraction directions for every wavelength; and an image-capturing element 11 that detects light diffracted by the diffraction grating 10.

The line-spectral-image acquiring unit 7 closes all the shutters 9, and then opens the shutter 9 that opens/closes one particular slit 8 in order to allow a line-shaped light beam out of the light from the subject to pass therethrough. The line-spectral-image acquiring unit 7 alternately and sequentially switches the open shutter 9 in the direction in which the slits 8 are arrayed, that is, in a direction that is orthogonal to a length direction (line direction) X of the slits 8. Thus, the slit 8 that allows a line-shaped light beam that will be incident on the diffraction grating 10 to pass therethrough is scanned in the direction in which the slits 8 are arrayed.

Rather than performing scanning using the slits 8 in this way, the line-spectral-image acquiring unit 7 may instead perform scanning by using a light reflecting body such as a mirror having a line shape as disclosed in paragraph {0056} and FIGS. 1 to 3 of Japanese Unexamined Patent Application Publication No. 2012-58037, or may instead perform scanning using an optical mechanical scanner (OMS) or a push-pull scanner (PBS).

The diffraction grating 10 is arranged across the entire length of the slits 8 in the line direction X, and light that has passed through any of the slits 8 is incident thereon from the same direction (direction substantially orthogonal to incidence surface of diffraction grating 10). A line-shaped light beam incident on the diffraction grating 10 is diffracted by the diffraction grating 10 in directions that depend on the wavelengths of the light beam and is incident on the image-capturing element 11 that is arranged so as to cover the range of diffraction.

The image-capturing element 11 has a plurality of pixels that are arrayed in the line direction X and in a direction orthogonal to the line direction X. The number of pixels arrayed in the line direction X determines the spatial resolution of the line spectral images. In addition, the number of pixels arrayed in the direction orthogonal to the line direction X determines the wavelength resolution of the line spectral images.

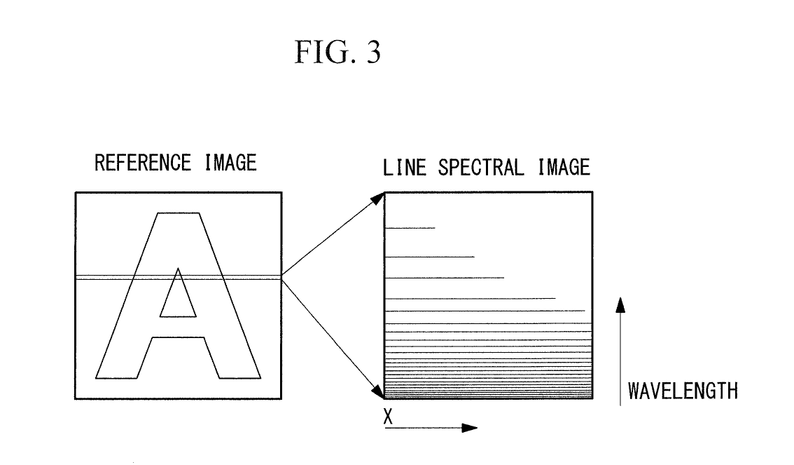

Therefore, as illustrated in FIG. 3, the line spectral image acquired for each line by the image-capturing element 11 is a two-dimensional image that represents a luminance sequence of the line direction X in one direction and a luminance sequence of a wavelength direction in another direction. A plurality of line spectral images such as the one illustrated in FIG. 3 are sequentially acquired by capturing an image while switching the position at which a shutter 9 is open.

Here, an image-capturing range of the area sensor of the reference-image acquiring unit 6 is set so as to encompass an image-capturing range in which an image is captured by scanning the slits 8 of the line-spectral-image acquiring unit 7.

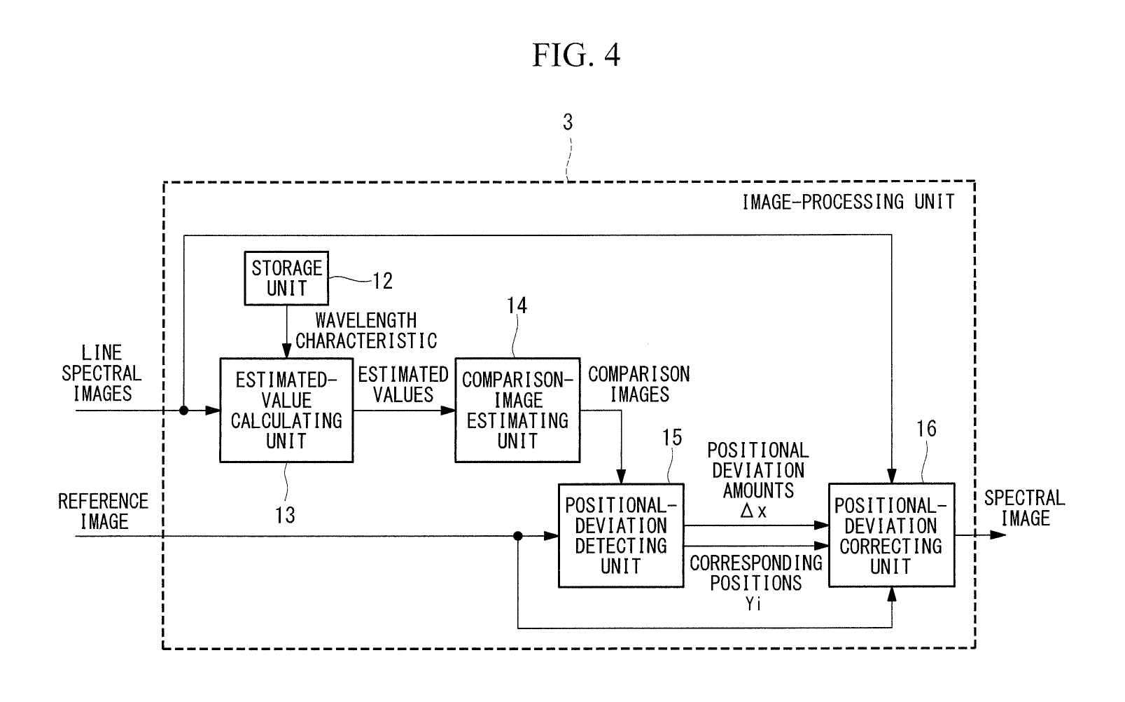

As illustrated in FIG. 4, the reference image and the plurality of line spectral images acquired by the image-acquiring unit 2 are input to the image-processing unit 3, and the image-processing unit 3 outputs a spectral image that has been corrected for positional deviation.

The image-processing unit 3 includes a storage unit 12 that stores a wavelength characteristic L(λ) of a light source used when capturing an image and a wavelength characteristic T(λ) of the frame-image acquiring unit that includes the reference-image acquiring unit 6.

The relationship between these wavelength characteristics is expressed by formula 1 below.

S(λ)=L(λ)T(λ) (1)

Here, S(λ) represents the wavelength characteristic stored in the storage unit 12.

In addition, as illustrated in FIG. 4, the image-processing unit 3 includes an estimated-value calculating unit 13 and a comparison-image estimating unit 14.

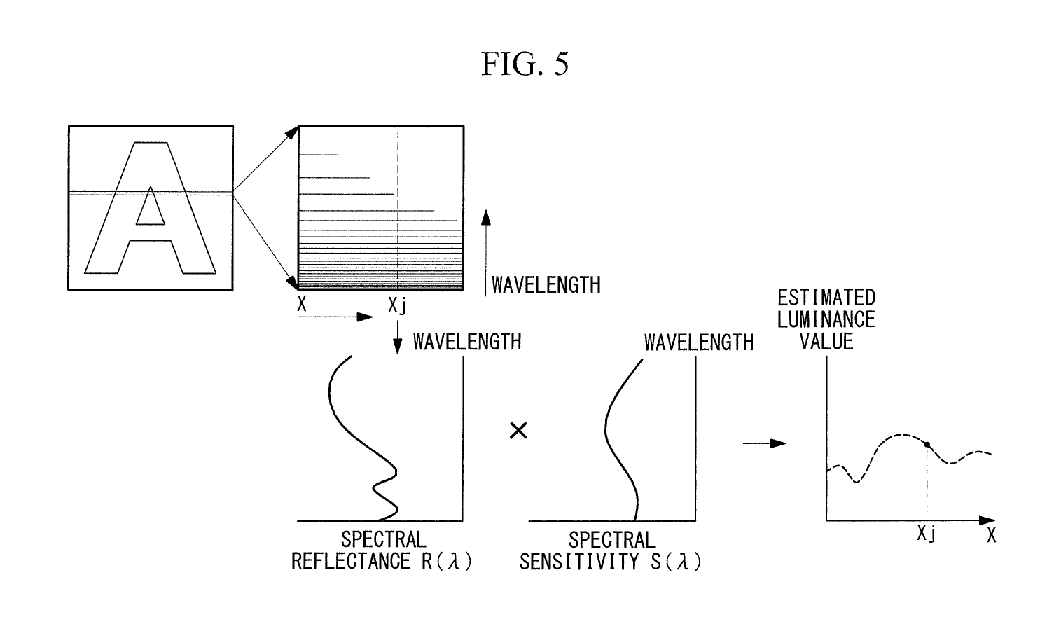

As illustrated in FIG. 5, the estimated-value calculating unit 13 calculates estimated luminance values V(xⱼ) at positions xⱼ by multiplying the wavelength characteristic R(λ) (spectral reflectance) at the positions xⱼ in the length direction X of the slit 8 of each input line spectral image by the wavelength characteristic S(λ) (spectral sensitivity), and integrating over the wavelength range over which image capturing was performed (refer to formula 2 below). In addition, the comparison-image estimating unit 14 generates line-shaped comparison images from the estimated luminance values at all the positions xⱼ calculated by the estimated-value calculating unit 13.

V(xi)=∫R(λS(λ)dλ (2)

Furthermore, as illustrated in FIG. 4, the image-processing unit 3 includes a positional-deviation detecting unit (line-spectral-image positional-deviation detecting unit) 15. As illustrated in FIG. 5, the positional-deviation detecting unit 15 specifies corresponding positions Yᵢ of the comparison images within the reference image and calculates positional deviation amounts Δx along the length direction X of the lines by acquiring correlations between the comparison images estimated by the comparison-image estimating unit 14 and the reference image.

The correlation calculation carried out in the positional-deviation detecting unit 15 is performed between each comparison image and each line of the reference image, and the lines of the reference image having the highest correlation values with the comparison images are selected as the corresponding positions Yᵢ of the respective comparison images. Then, positional deviation amounts Δx between the reference image and the comparison images of the respective lines that are at the selected corresponding positions Yᵢ are calculated.

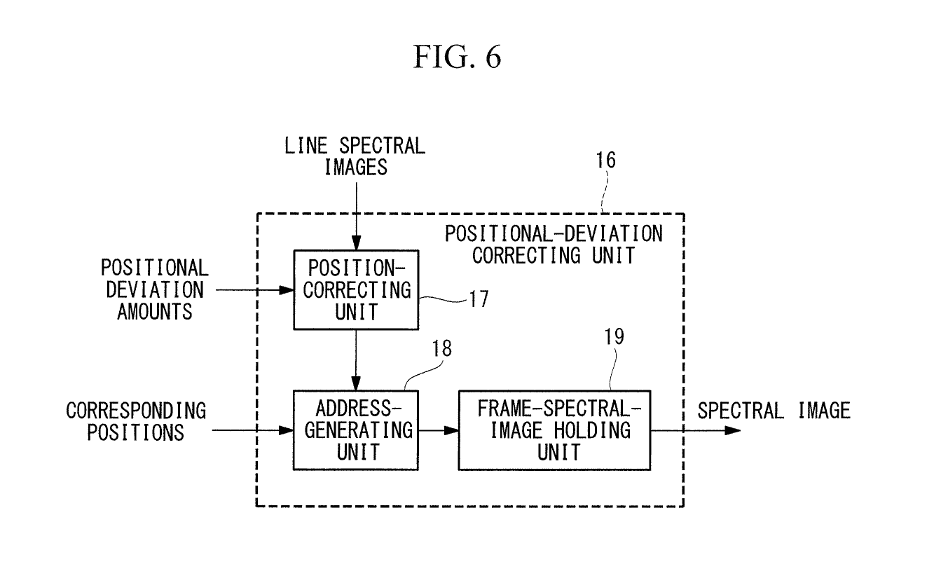

In addition, the image-processing unit 3 includes a positional-deviation correcting unit 16 that fits the line spectral images, which were used to estimate the comparison images, to the corresponding positions Yᵢ within the reference image, which were selected by the positional-deviation detecting unit 15, by shifting the line spectral images by the positional deviation amounts Δx detected by the positional-deviation detecting unit 15 in the same manner. As illustrated in FIG. 6, the positional-deviation correcting unit 16 includes a position-correcting unit 17, a frame-spectral-image holding unit 19, and an address-generating unit 18.

The position-correcting unit 17 shifts the line spectral images of all the lines acquired by the line-spectral-image acquiring unit 7 in the X direction by the positional deviation amounts Δx detected by the positional-deviation detecting unit 15.

The frame-spectral-image holding unit 19 has a number of frequency bands (number of pixels) equal to the number of line spectral images of the respective lines acquired by the line-spectral-image acquiring unit 7. In addition, the address-generating unit 18 generates addresses in the frame-spectral-image holding unit 19 for the line spectral images, which have been corrected by the position-correcting unit 17, on the basis of information of the corresponding positions Y₁, within the reference image, of the line spectral images specified by the positional-deviation detecting unit 15, and stores the line spectral images by writing the line spectral images to the corresponding addresses in the frame-spectral-image holding unit 19, which handles all the frequency bands. Thus, line spectral images that have been corrected for positional deviation are generated.

The operation of the thus-configured spectral-image acquisition device 1 according to this embodiment will now be described.

In order to acquire a spectral image using the spectral-image acquisition device 1 according to this embodiment, the image-capturing lens 4 is arranged so as to face the subject, and, in the light from a light source, light reflected by the subject is collected by the image-capturing lens 4.

The collected light is branched into two optical paths L1 and L2 by the splitting unit 5, a reference image is acquired by the reference-image acquiring unit 6 arranged along one optical path L1, and a plurality of line spectral images are acquired by the line-spectral-image acquiring unit 7 arranged along the other optical path L2.

The reference-image acquiring unit 6 is formed of an area sensor such as a CCD, and therefore, the reference-image acquiring unit 6 can instantaneously acquire a two-dimensional monochrome image without there being any positional deviations at the individual positions.

In the line-spectral-image acquiring unit 7, the shutters 9 that close the slits 8a are sequentially opened one by one, whereby a line-shaped light beam that extends in the line direction X and passes through the open slit 8 is diffracted across every wavelength by the diffraction grating 10, and a line spectral image is acquired for every line by the image-capturing element 11. At this time, deviations occur in the acquisition times of the line spectral images due to the slits 8 being sequentially opened, and positional deviations are generated in the case where the subject is moving, for example.

Therefore, when the reference image and the plurality of line spectral images acquired by the image-acquiring unit 2 are input to the image-processing unit 3, estimated luminance values at positions x₃ are calculated in the estimated-value calculating unit 13 by multiplying a wavelength characteristic (spectral reflectance) at each position xⱼ in the length direction X of the slit 8 of each input line spectral image by a wavelength characteristic stored in the storage unit 12.

In addition, the comparison-image estimating unit 14 of the image-processing unit 3 generates line-shaped comparison images from the estimated luminance values at all the positions xⱼ calculated by the estimated-value calculating unit 13.

Furthermore, in the image-processing unit 3, the positional-deviation detecting unit 15 specifies corresponding positions Yᵢ for the comparison images within the reference image by acquiring correlations between the comparison images estimated by the comparison-image estimating unit 14 and the reference image, and calculates positional deviation amounts Δx along the length direction X of the lines.

Then, in the image-processing unit 3, the positional-deviation correcting unit 16 fits the line spectral images to the corresponding positions Yᵢ inside the reference image on the basis of the detected positional deviation amounts Δx. Thus, even when positional deviations are generated between a plurality of line spectral images acquired by sequentially switching a slit 8, the line spectral images can be aligned with each other by referring to the reference image acquired instantaneously, and therefore, there is an advantage in that it is possible to generate a spectral image in which positional deviations can be suppressed in accordance with movement of the subject.

Hereafter, a spectral-image acquisition device according to a second embodiment of the present invention will be described while referring to the drawings.

In the description of this embodiment, parts having the same configuration as in the spectral-image acquisition device 1 according to the first embodiment described above are denoted by the same symbols, and a description thereof is omitted.

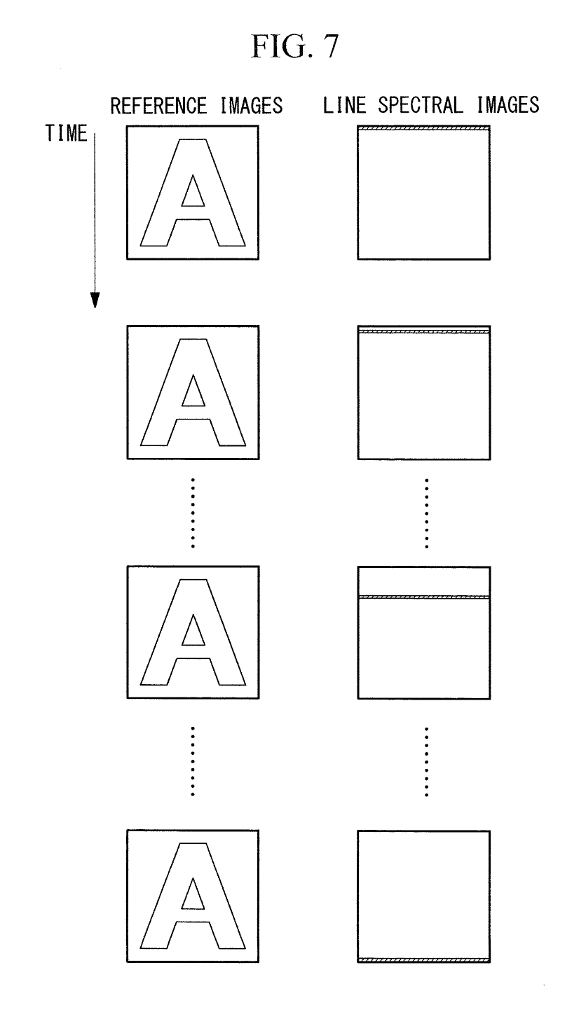

As illustrated in FIG. 7, the spectral-image acquisition device according to this embodiment differs from the spectral-image acquisition device 1 according to the first embodiment in that the reference-image acquiring unit 6 acquires a plurality of reference images at substantially the same timings as the timings at which the line spectral images are acquired by the line-spectral-image acquiring unit 7, and also differs in terms of the image processing performed in an image-processing unit 20.

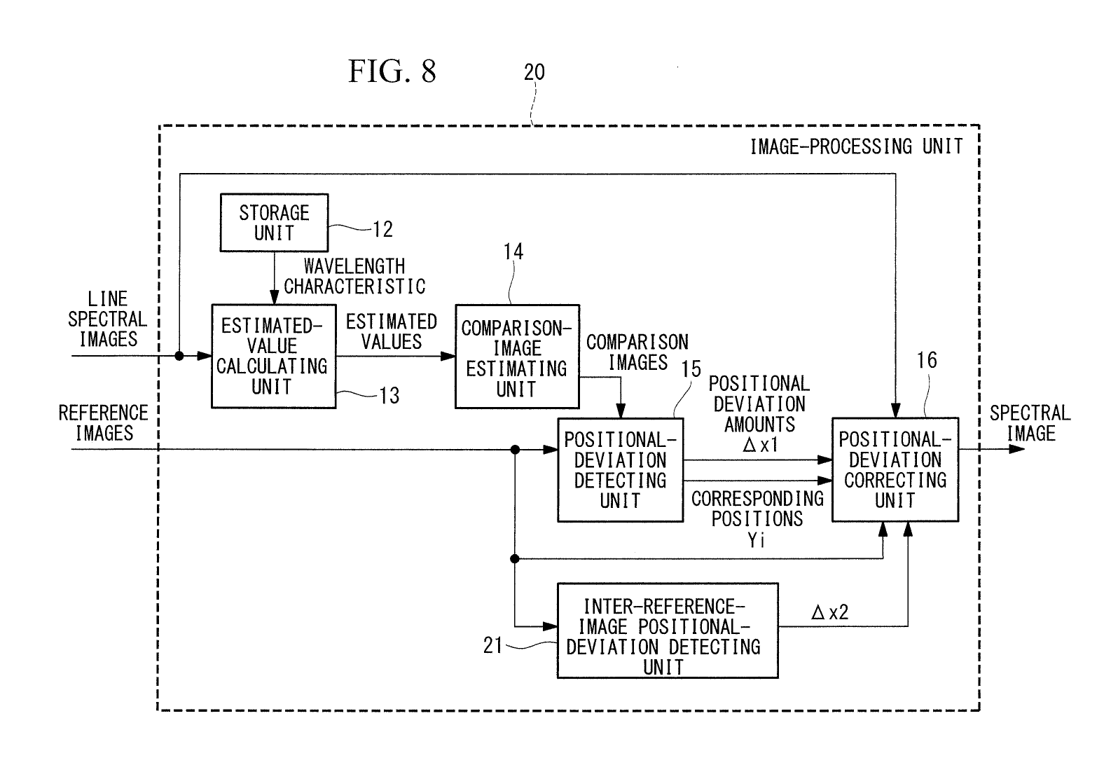

As illustrated in FIG. 8, the image-processing unit 20 further includes an inter-reference-image positional-deviation detecting unit (inter-frame-image positional-deviation detecting unit) 21 that detects the amounts of positional deviation between the plurality of reference images acquired by the reference-image acquiring unit 6, and the positional-deviation correcting unit 16 performs correction using the amounts of positional deviation between the reference images.

In other words, in the same way as in the first embodiment, a first positional deviation amount Δx1 is detected using a first reference image and a first line spectral image acquired at substantially the same time, and the first line spectral image is saved at a corresponding position in the first reference image.

Next, in the same way as in the first embodiment, a second positional deviation amount Δx1 is detected using a second reference image and a second line spectral image acquired at substantially the same time. In the case where the acquisition times of the second reference image and the second line spectral image are exactly the same, the second positional deviation amount is zero, and therefore, this processing is processing in which the corresponding position Yᵢ is specified on the basis of the correlation between the comparison image, which is obtained using the second line spectral image, and the second reference image.

The inter-reference-image positional-deviation detecting unit 21 detects a third positional deviation amount Δx2 between the first reference image and the second reference image. Next, the positional-deviation correcting unit 16 corrects the positional deviation by making the second positional deviation amount Δx1 and the third positional deviation amount Δx2 match each other, and saves the second line spectral image at a corresponding position Yᵢ in the first reference image. Thereafter, a spectral image in which positional deviation has been suppressed can be acquired by repeating this operation while using the first reference image as a standard reference image.

In other words, the spectral-image acquisition device according to this embodiment has advantages in that it is easy to acquire a correlation between a reference image and a line spectral image acquired at substantially the same time, and it is also possible to perform correlation between two-dimensional images with few errors.

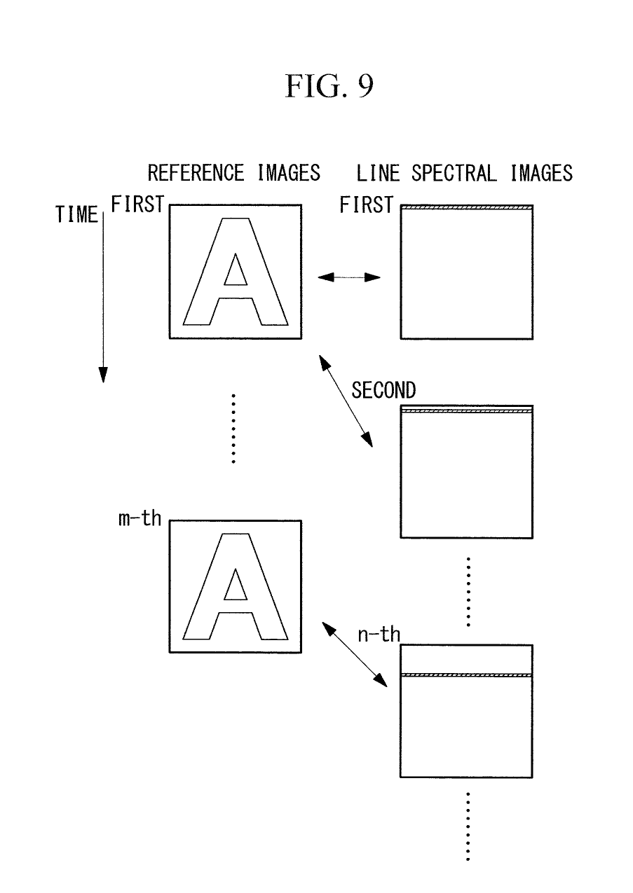

In this embodiment, it is assumed that the reference images are acquired simultaneously with the line spectral images, but a plurality of reference images may instead be acquired non-simultaneously with the line spectral images. In this case, as illustrated in FIG. 9, it is sufficient that the detection of the amount of positional deviation performed by the line-spectral-image positional-deviation detecting unit 15 be performed by selecting the reference image having an acquisition time that is closest to that of the line spectral image.

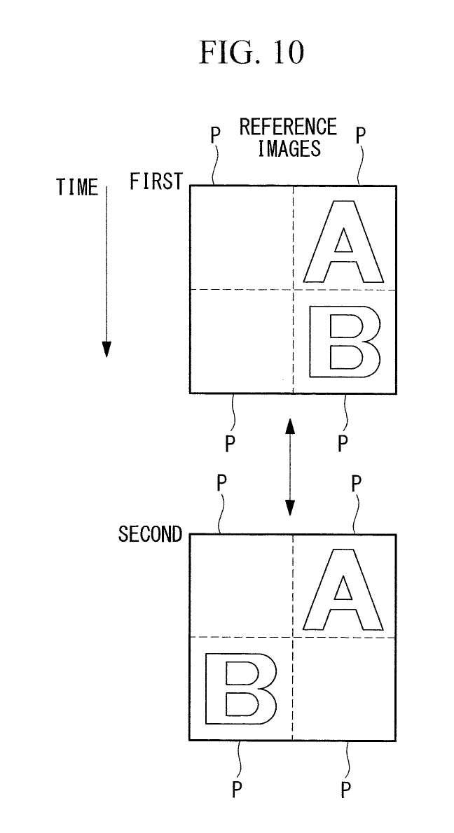

Furthermore, the inter-reference-image positional-deviation detecting unit 21 may detect local positional deviations within reference images. In the example illustrated in FIG. 10, the acquisition times of a first line spectral image and a first reference image, and a second line spectral image and a second reference image are close to each other, and therefore, detection of positional deviations can be easily performed. Detection of local positional deviations between the first reference image and the second reference image is performed.

Detection of local positional deviations between reference images is performed by dividing each reference image into a plurality of regions P, and comparing the reference images in each region P. Thus, there is an advantage that, even when displacement of the subject occurs in the periods between the individual line spectral images being acquired, a corresponding position for fitting the line spectral image to a first reference image, which serves as a standard reference image, can be easily specified. The regions P may be set so as to overlap each other.

In addition, the reference-image acquiring unit 6 may acquire two or more reference images that are separated from each other by a time interval that is sufficiently larger than the time interval at which adjacent line spectral images are acquired.

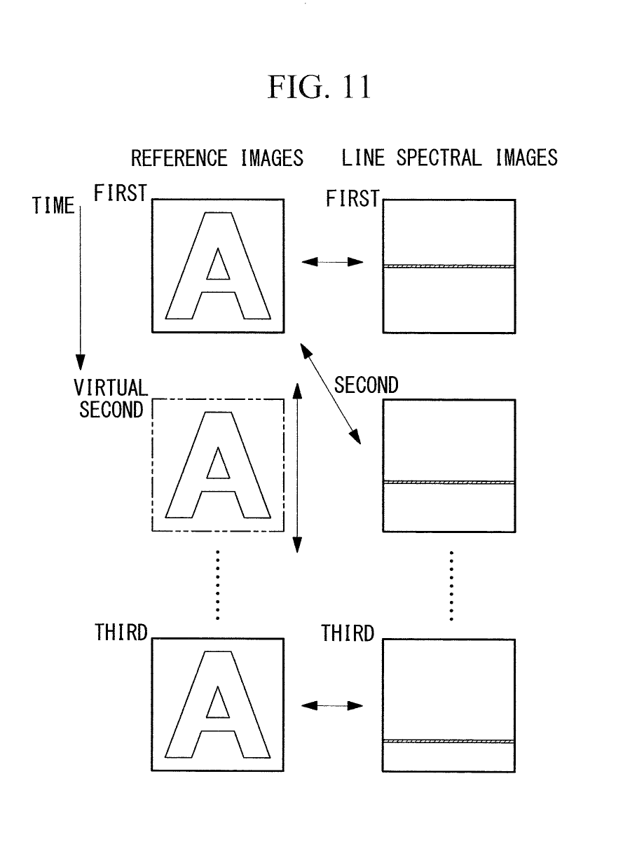

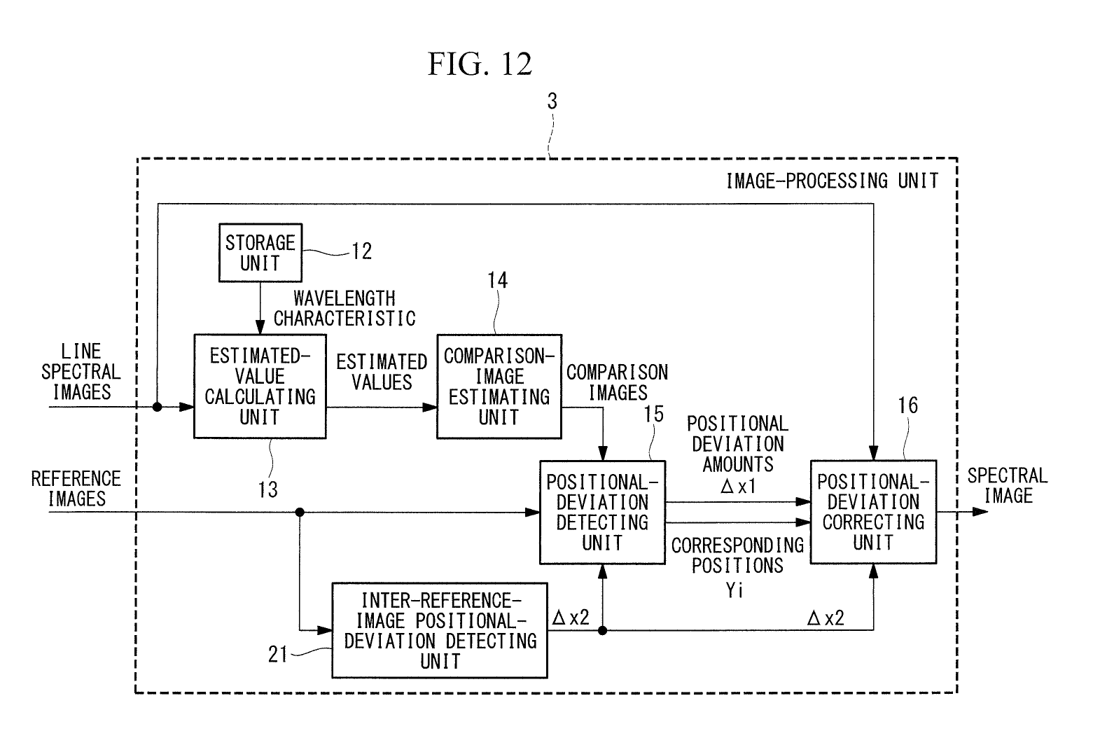

In this case, a timing exists at which a reference image that corresponds to a line spectral image is not acquired. As illustrated in FIGS. 11 and 12, the spectral-image acquisition device generates a spectral image by generating a virtual second reference image at a timing of a second line spectral image for which a reference image is not acquired, and embedding the second line spectral image in the generated virtual reference image.

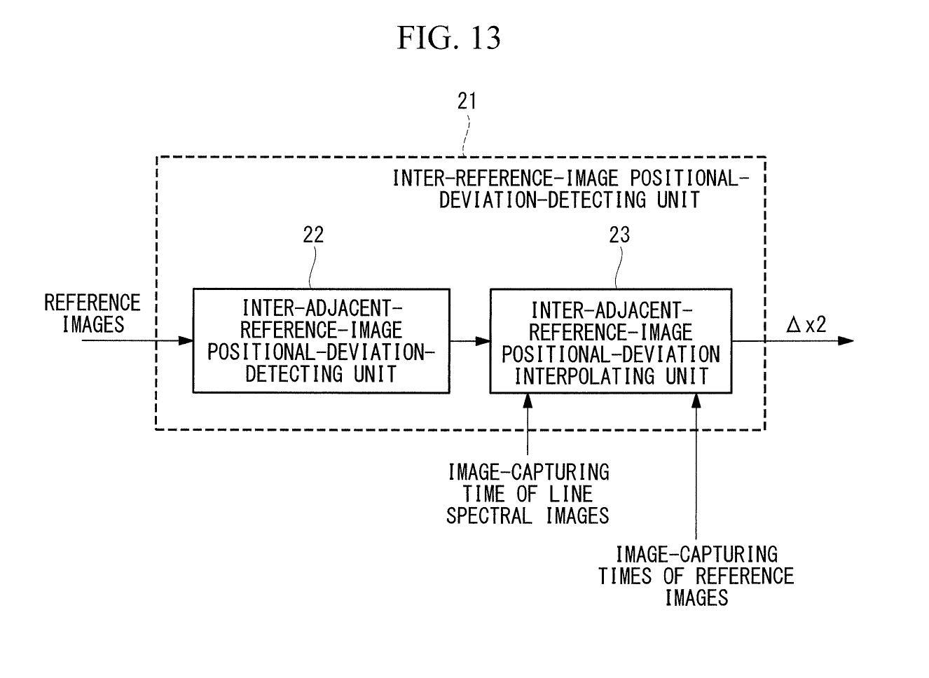

As illustrated in FIG. 13, in order to generate a virtual reference image, the inter-reference-image positional-deviation detecting unit 21 in FIG. 12 includes an inter-adjacent-reference-image positional-deviation detecting unit 22 that detects an amount of positional deviation between actually acquired adjacent images, and an inter-adjacent-reference-image positional-deviation interpolating unit 23 that generates a virtual reference image by using a positional deviation amount (Δxref) between the detected adjacent reference images, an image-capturing time (t1) of a line spectral image, and image-capturing times (tref0, tref1) of two adjacent reference images. The inter-adjacent-reference-image positional-deviation interpolating unit 23 acquires a positional deviation amount Δx2 of the virtual reference image using the following formula.

Δx2=Δxref(t1−tref0)/(tref1−tref0)

The processing after generating the virtual reference image is the same as in the case where a reference image is acquired in association with a line spectral image.

The number of reference images acquired can be reduced in this way.

In addition, the reference-image acquiring unit 6 acquires reference images at a shorter time interval than that at which the line spectral images are acquired by the line-spectral-image acquiring unit 7, the inter-reference-image positional-deviation detecting unit 21 detects an amount of positional deviation between adjacent acquired reference images and combines the amounts of positional deviation up to the reference images corresponding to the line spectral images, and as a result, a spectral image in which positional deviation has been suppressed can be acquired by fitting the line spectral images that have undergone positional correction for the amounts of positional deviation to the corresponding positions in the reference images.

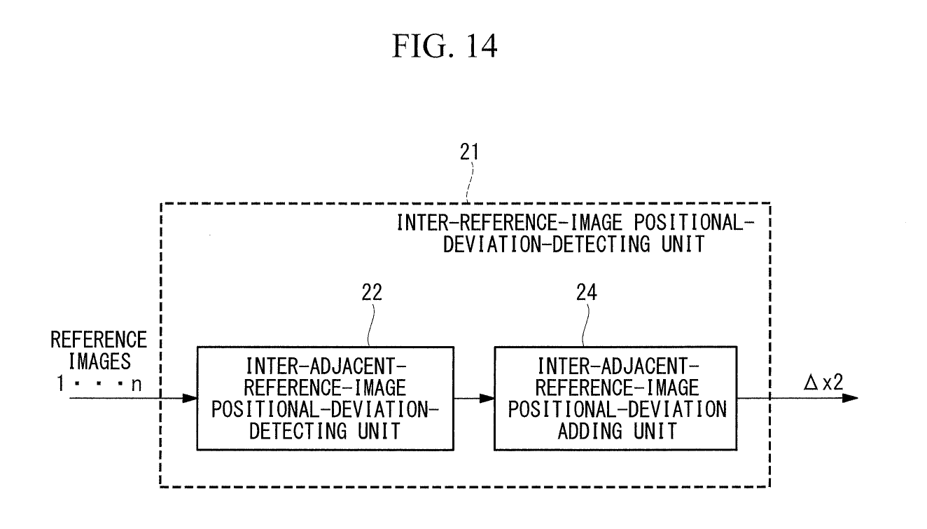

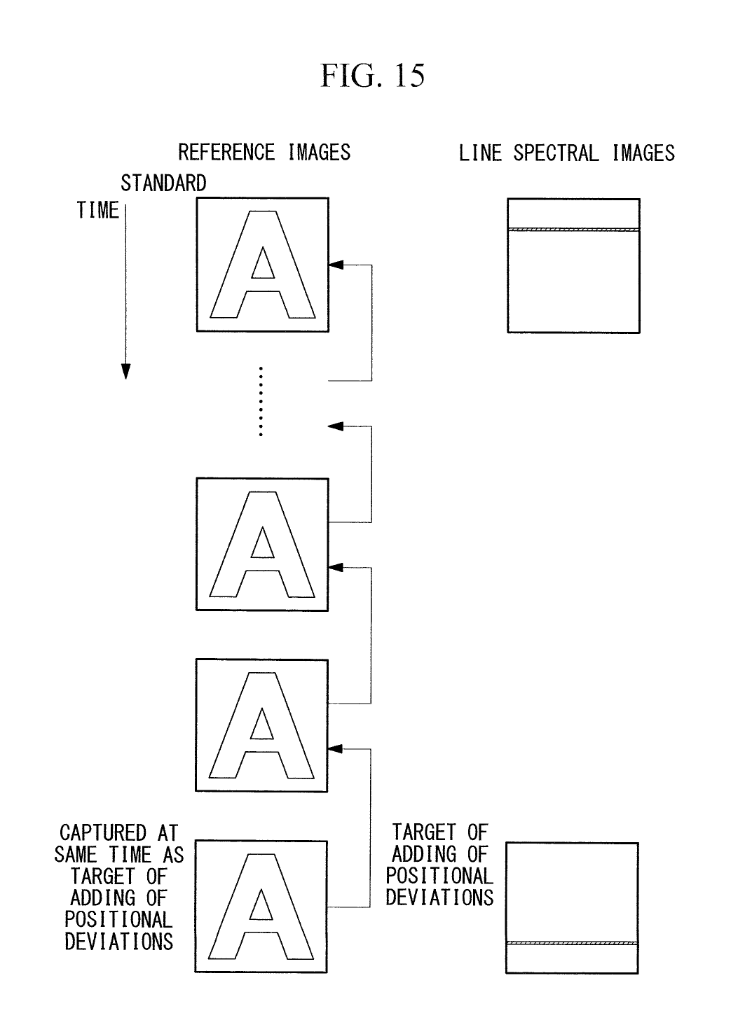

In this case, as illustrated in FIG. 14, the inter-reference-image positional-deviation detecting unit 21 includes the inter-adjacent-reference-image positional-deviation detecting unit 22 that detects an amount of positional deviation between adjacent reference images, and an inter-adjacent-reference-image positional-deviation-adding unit 24 that adds together the respective amounts of positional deviation detected by the inter-adjacent-reference-image positional-deviation detecting unit 22. As illustrated in FIG. 15, the inter-reference-image positional-deviation detecting unit 21 detects the amounts of positional deviation between adjacent reference images and adds together the detected amounts of positional deviation, and thereby acquires the amount of positional deviation between a reference image, which serves as a standard reference image, and a reference image corresponding to a line spectral image.

In addition, although it is assumed that the correlation calculation is performed between the comparison images and the respective lines within a reference image in the positional-deviation detecting unit 15 in the above-described embodiment, alternatively, a line having the highest correlation value can be detected by performing a correlation calculation for a smaller number of lines by performing a correlation calculation using a pre-measured position in a reference image as a reference based on scanning information of the slits 8 (for example, image-capturing interval and scanning position), and the time taken to perform the calculation processing can be shortened.

In addition, although a monochrome image acquired by an area sensor was exemplified as a reference image in the above-described embodiments, the reference image is not limited to a monochrome image so long as the reference image is an image that can be acquired at a higher speed than a line spectral image. For example, it is sufficient that the reference image be an image that contains fewer color signals than a line spectral image.

As a result, the above-described embodiments lead the following aspects.

An aspect of the present invention provides a spectral-image acquisition device that includes: a line-spectral-image acquiring unit that acquires a plurality of line spectral images by deflecting a scanned line-shaped light beam across all wavelengths at each position in a length direction thereof; a frame-image acquiring unit that has an image-capturing range that encompasses that over which image capturing is performed by the line-spectral-image acquiring unit, and that acquires a two-dimensional frame image that contains fewer color signals than the line spectral images; a comparison-image estimating unit that estimates comparison images for all lines on the basis of the line spectral images acquired by the line-spectral-image acquiring unit and a wavelength characteristic of the frame-image acquiring unit; a line-spectral-image positional-deviation detecting unit that detects amounts of positional deviation between the comparison images estimated by the comparison-image estimating unit and corresponding positions within the frame image; and a positional-deviation correcting unit that fits the line spectral images, which were used to estimate the comparison images, to the corresponding positions within the frame image on the basis of the amounts of positional deviation detected by the line-spectral-image positional-deviation detecting unit.

According to this aspect, the line-spectral-image acquiring unit successively acquires a plurality of line spectral images in a scanning direction, and the frame-image acquiring unit acquires a frame image. Since the line spectral images are successively acquired by performing scanning, the line spectral image have different acquisition times, and therefore, positional deviations are generated therebetween. However, since the frame image contains fewer color signals than the line spectral images, the same image-capturing range as that captured by all the line spectral images can be captured in a shorter period of time than for the line spectral images, and deviations within the image can be suppressed.

The comparison-image-estimating unit estimates line-shaped comparison images that would be acquired by the frame-image acquiring unit from the line spectral images and the wavelength characteristic of the frame-image acquiring unit, and the line-spectral-image positional-deviation detecting unit detects the amounts of positional deviation between the estimated comparison images and corresponding positions within the frame image. The positional-deviation correcting unit fits the line spectral images, which were used to generate the comparison images, to the corresponding positions within the frame image on the basis of the detected amounts of positional deviation, and thereby, a spectral image in which positional deviation has been suppressed can be acquired.

In other words, although positional deviations are generated in the line spectral images when the subject moves, for example, due to the different acquisition times of the line spectral images, the positional deviations are corrected by referring to the frame image in which deviations are suppressed, and therefore, a spectral image in which positional deviations have been suppressed can be easily obtained.

In the above-described aspect, the frame-image acquiring unit may acquire the frame image, which serves as a standard frame image, and at least one more frame image separated by a time interval with respect to the frame image that serves as the standard frame image. The line-spectral-image positional-deviation detecting unit may detect the amount of positional deviations by selecting the frame image that has the closest acquisition time to the line spectral images, which were used to estimate the comparison images. The spectral-image acquisition device may further include an inter-frame-image positional-deviation detecting unit that detects an amount of positional deviation between the frame image selected by the line-spectral-image positional-deviation detecting unit and the frame image that serves as a standard frame image. The positional-deviation correcting unit may fit the line spectral images, which were used to generate the comparison images, to corresponding positions within the frame image that serves as the standard frame image on the basis of the amounts of positional deviation detected by the line-spectral-image positional-deviation detecting unit and the amount of positional deviation detected by the inter-frame-image positional-deviation detecting unit.

With this configuration, the frame image having the closest acquisition time is selected as the frame image to be compared with the comparison images, and therefore, the amounts of positional deviation is reduced and the amounts of positional deviation can be easily detected. The detection of positional deviation between the frame image serving as the reference and the selected frame image is carried out by comparing two-dimensional frame images, and therefore, the amount of positional deviation can be more easily detected.

In addition, in the above-described aspect, the frame-image acquiring unit may acquire the frame images at times that correspond to acquisition times of the line spectral images acquired by the line-spectral-image acquiring unit.

With this configuration, since the frame images that are to be compared with the comparison images estimated from the line spectral images are acquired at substantially the same times, the amounts of positional deviation detected by the line-spectral-image positional-deviation detecting unit are reduced and the amounts of positional deviation can be easily detected.

In addition, in the above-described aspect, the inter-frame-image positional-deviation detecting unit may locally detect positional deviation between frame images.

With this configuration, even if the subject within the image-capturing range locally changes as time passes, positional deviations between frame images can be accurately detected and a spectral image can be acquired with high accuracy.

Furthermore, in the above-described aspect, the frame-image acquiring unit may acquire the frame image, which serves as a standard frame image, and acquire at least one more frame image separated by a time interval with respect to the frame image that serves as the standard frame image. The spectral-image acquisition device may further include a positional-deviation-amount-calculating unit that calculates amounts of positional deviation, with respect to the frame image that serves as the standard frame image, of the frame images at acquisition times of the line spectral images, which were used to estimate the comparison images, from the acquisition time of the frame image that serves as the standard frame image, the acquisition time of another frame image, and the acquisition times of the comparison images when detecting the corresponding positions of the comparison images with respect to the frame image serving as a standard frame image. The positional-deviation correcting unit may fit the line spectral images, which were used to estimate the comparison images, to the corresponding positions within the frame image that serves as the standard frame image on the basis of the amounts of positional deviation detected by the line-spectral-image positional-deviation detecting unit and the amounts of positional deviation calculated by the positional-deviation-amount-calculating unit.

With this configuration, the number of frame images that are acquired in order to calculate an amount of positional deviation by being compared with comparison images can be reduced.

The present invention affords the advantage that it is possible to generate a spectral image in which positional deviations are suppressed in accordance with the movement of a subject.

### REFERENCE SIGNS LIST

1 spectral-image acquisition device
6 reference-image acquiring unit (frame-image acquiring unit)
7 line-spectral-image acquiring unit
8 slit
14 comparison-image estimating unit
15 positional-deviation detecting unit (line-spectral-image positional-deviation detecting unit)
16 positional-deviation correcting unit
21 inter-reference-image positional-deviation detecting unit (inter-frame-image positional-deviation detecting unit)

1. A spectral-image acquisition device comprising:
a line-spectral-image acquiring unit that acquires a plurality of line spectral images by deflecting a scanned line-shaped light beam across all wavelengths at each position in a length direction thereof;
a frame-image acquiring unit that has an image-capturing range that encompasses that over which image capturing is performed by the line-spectral-image acquiring unit, and that acquires a two-dimensional frame image that contains fewer color signals than the line spectral images;
a comparison-image estimating unit that estimates comparison images for all lines on the basis of the line spectral images acquired by the line-spectral-image acquiring unit and a wavelength characteristic of the frame-image acquiring unit;
a line-spectral-image positional-deviation detecting unit that detects amounts of positional deviation between the comparison images estimated by the comparison-image estimating unit and corresponding positions within the frame image; and
a positional-deviation correcting unit that fits the line spectral images, which were used to estimate the comparison images, to the corresponding positions within the frame image on the basis of the amounts of positional deviation detected by the line-spectral-image positional-deviation detecting unit.

2. A spectral-image acquisition device according to claim 1,
wherein the frame-image acquiring unit acquires the frame image, which serves as a standard frame image, and at least one more frame image separated by a time interval with respect to the frame image that serves as the standard frame image;
the line-spectral-image positional-deviation detecting unit detects the amounts of positional deviation by selecting the frame image that has the closest acquisition time to the line spectral images, which were used to estimate the comparison images;
the spectral-image acquisition device further comprising:
an inter-frame-image positional-deviation detecting unit that detects an amount of positional deviation between the frame image selected by the line-spectral-image positional-deviation detecting unit and the frame image that serves as a standard frame image;
wherein the positional-deviation correcting unit fits the line spectral images, which were used to generate the comparison images, to corresponding positions within the frame image that serves as the standard frame image on the basis of the amounts of positional deviation detected by the line-spectral-image positional-deviation detecting unit and the amount of positional deviation detected by the inter-frame-image positional-deviation detecting unit.

3. A spectral-image acquisition device according to claim 2,
wherein the frame-image acquiring unit acquires the frame images at times that correspond to acquisition times of the line spectral images acquired by the line-spectral-image acquiring unit.

4. A spectral-image acquisition device according to claim 2, wherein the inter-frame-image positional-deviation detecting unit locally detects positional deviation between frame images.

5. A spectral-image acquisition device according to claim 1,
wherein the frame-image acquiring unit acquires the frame image, which serves as a standard frame image, and at least one more frame image separated by a time interval with respect to the frame image that serves as the standard frame image;
the spectral-image acquisition device further comprising:
a positional-deviation-amount-calculating unit that calculates amounts of positional deviation, with respect to the frame image that serves as the standard frame image, of the frame images at the acquisition time of the line spectral images, which were used to estimate the comparison images, from the acquisition time of the frame image that serves as the standard frame image, the acquisition time of another frame image, and the acquisition times of the comparison images when detecting the corresponding positions of the comparison images with respect to the frame image serving as a standard frame image;
wherein the positional-deviation correcting unit fits the line spectral images, which were used to estimate the comparison images, to corresponding positions within the frame image that serves as the standard frame image on the basis of the amounts of positional deviation detected by the line-spectral-image positional-deviation detecting unit and the amounts of positional deviation calculated by the positional-deviation-amount-calculating unit.
